(19) United States
(12) Patent Application Publication
(10) Pub. No.: US 2018/0239577 A1
(43) Pub. Date: Aug. 23, 2018

(54) MUSIC PROVIDING METHOD AND MUSIC PROVIDING SYSTEM

(71) Applicant: Yusik KIM, Seongnam-si, Gyeonggi-do (KR)

(72) Inventor: Yusik KIM, Seongnam-si, Gyeonggi-do (KR)

(21) Appl. No.: 15/554,710

(22) PCT Filed: Mar. 2, 2016
(86) PCT No.: PCT/KR2016/002043

§ 371 Date: Aug. 30, 2017

(30) Foreign Application Priority Data
Mar. 6, 2015 (KR) 10-2015-0031502
Feb. 2, 2016 (KR) 10-2016-0012649

(51) Int. Cl. G06F 3/16; G06F 17/30

(52) U.S. Cl. CPC G06F 3/16; G06F 17/30775

(57) ABSTRACT

A music providing system that provides and/or plays a music file, the music providing system comprises: a storage unit configured to store tag information corresponding to the music file such that the tag information is matched with the music file; and a play unit configured to play the music file.

### TECHNICAL FIELD

The present invention relates to a music providing method and a music providing system, and more particularly, to a method and system for allocating tag information corresponding to a music file, creating a music file group according to the allocated tag information, and providing the music file group to other users. The method and system may provide a function of receiving any written-tag information of the music file from a user and storing the received written-tag information such that the written-tag information is matched with the music file.

### BACKGROUND ART

In recent years, along with higher performance, miniaturization, and lower power consumption of electronic devices, smart devices are part of overall human life. Now, there is a growing expectation for smart devices to assist emotional purification beyond functional convenience of human life. That is, there is a need for smart devices to emotionally develop.

In the context of the music providing field, a technology has been developed to focus on a method of conveniently receiving a digital music file and playing the received digital music file at any time (Korean Patent Publication No. 2003-0087791, entitled “THE METHOD OF RECEIVING, STORING AND PLAYING DIGITALAUDIO SOURCE.”

However, a technology capable of providing a music file according to a listener's emotion has not been sufficiently developed.

Unlike watching videos, it is not necessary to view a screen while listening to music. Accordingly, this allows listening music for a long time during a moving time or a workout time. In this case, a random play function is used. Most people have music files about hundreds of songs or more, but have difficulty in selectively listening to songs they want to listen to depending on purposes, tastes, emotions, and atmospheres. In the related art, it is cumbersome to select an individual file or to create a new folder and then move a music file to the folder in order to selectively listen to a desired song.

Accordingly, there is a need for a technology capable of solving the above problems.

The foregoing background is technical information the inventors have possessed or obtained in the course of the present invention, and thus may not be publicly known before the filing of this application.

### DETAILED DESCRIPTION OF THE INVENTION

### Technical Problem

An embodiment of the present invention is directed to providing a music file depending on a listener's purpose, taste, emotion, and atmosphere.

Also, an embodiment of the present invention is directed to providing a music file group depending on a listener's purpose, taste, emotion, and atmosphere.

Also, an embodiment of the present invention is directed to providing a playlist composed of music files depending on a listener's purpose, taste, emotion, and atmosphere.

Also, an embodiment of the present invention is directed to share tag information of a music file and a music file group with other people depending on a listener's purpose, taste, emotion, and atmosphere.

Also, an embodiment of the present invention is directed to forming a new benefit structure in a music file market by distributing benefits obtained by sharing tag information of a music file and a music file group with other people depending on a listener's purpose, taste, emotion, and atmosphere.

### Technical Solution

As a technical solution for the above technical problems, according to a first aspect of the present invention, there is disclosed a music providing method performed by a music providing system, the music providing method including storing tag information corresponding to a music file such that the tag information is matched with the music file and playing the music file.

According to a second aspect of the present invention, there is disclosed a music providing system that provides and/or plays a music file, the music providing system including a storage unit configured to store tag information corresponding to the music file such that the tag information is matched with the music file and a play unit configured to play the music file.

Also, according to a third aspect of the present invention, there is disclosed a computer program performed by a music providing system and stored in a recording medium to perform the music providing method according to the first aspect.

Also, according to a fourth aspect of the present invention, there is disclosed a computer-readable recording medium having a program recorded thereon to perform the method according to the first aspect.

### Advantageous Effects

According to any one of the technical solutions of the present invention, an embodiment of the present invention can provide a music file depending on a listener's purpose, taste, emotion, and atmosphere.

Also, according to any one of the technical solutions of the present invention, an embodiment of the present invention can provide a group of music files depending on a listener's purpose, taste, emotion, and atmosphere.

Also, according to any one of the technical solutions of the present invention, an embodiment of the present invention can provide a playlist composed of music files depending on a listener's purpose, taste, emotion, and atmosphere.

Also, according to any one of the technical solutions of the present invention, an embodiment of the present invention can share tag information of a music file and a music file group with other people depending on a listener's purpose, taste, emotion, and atmosphere.

Also, according to any one of the technical solutions of the present invention, an embodiment of the present invention can form a new benefit structure in a music file market by distributing benefits obtained by sharing tag information of a music file and a music file group with other people depending on a listener's purpose, taste, emotion, and atmosphere.

Advantageous effects of the invention are not limited to the aforementioned effects, and other advantageous effects that are not described herein should be clearly understood by those skilled in the art from the following description.

### DESCRIPTION OF THE DRAWINGS

FIG. 1 is a diagram showing a configuration of a music providing system according to an embodiment of the present invention.

FIG. 2 is a block diagram showing a music providing system according to an embodiment of the present invention.

FIG. 3 is a flowchart illustrating a musing providing method according to an embodiment of the present invention.

### BEST MODE

Hereinafter, embodiments of the present invention will be described in detail to be easily embodied by those skilled in the art with reference to the accompanying drawings. The present invention may, however, be embodied in many different forms and should not be construed as being limited to the embodiments set forth herein. In the accompanying drawings, portions irrelevant to the description of the example embodiments will be omitted for clarity. Moreover, like reference numerals refer to like elements throughout.

In this disclosure, when one part (or element, device, etc.) is referred to as being “connected” to another part (or element, device, etc.), it should be understood that the former can be “directly connected” to the latter, or “electrically connected” to the latter via an intervening part (or element, device, etc.). Furthermore, when one part is referred to as “comprising” (or “including” or “having”) other elements, it should be understood that the part can comprise (or include or have) only those elements or other elements as well as those elements unless specifically described otherwise.

Hereinafter, the present invention will be described in detail with reference to the accompanying drawings.

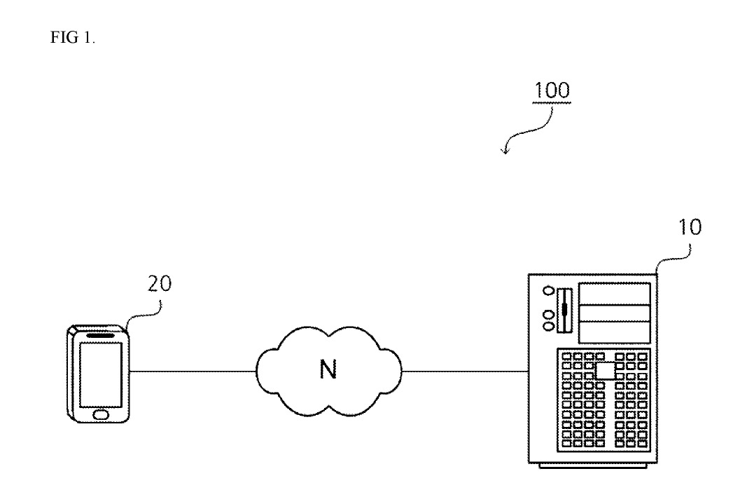

FIG. 1 is a diagram showing a configuration of a music providing system 100 according to an embodiment of the present invention.

The music providing system 100 is an apparatus for performing a music providing method according to an embodiment of the present invention and, for example, may call up a list index of a newly created music file group and play a music file. In detail, the music providing system 100 may include a music file providing server 10 configured to provide a music file and a user terminal 20 configured to play the music file.

The music file providing server 10 may store a music file and various kinds of data associated therewith and may transmit or receive data for playing music to or from the user terminal 20 through a network N.

In this case, the network N may be implemented with any kind of wired or wireless network such as a local area network (LAN), a wide area network (WAN), a value added network (VAN), a personal area network (PAN), a mobile radio communication network, a wireless broadband (Wibro) network, a mobile Worldwide Interoperability for Microwave Access (WiMAX) network, a High Speed Downlink Packet Access (HSDPA) network, or a satellite communication network.

Also, the music providing system 100 may include the user terminal 20. The user terminal 20 may be implemented with a computer, a portable terminal, a television, or a wearable device capable of connecting to the music file providing server 10 or other user terminals through the network N. Here, the computer may include, for example, a notebook, a desktop, and a laptop which are equipped with a web browser, and the portable terminal, which is a wireless communication device having portability and mobility, may include, for example, any kind of handheld wireless communication device such as a personal communication system (PCS), a personal digital cellular (PDC) device, a personal handyphone system (PHS), a personal digital assistant (PDA), a Global System for Mobile communications (GSM) device, an International Mobile Telecommunication (IMT)-2000 device, a Code Division Multiple Access (CDMA)-2000 device, a W-Code Division Multiple Access (W-CDMA) device, a wireless broadband (WiBro) device, a smartphone, or a mobile WiMAX device. Also, the television may include an Internet Protocol (IP) TV, an Internet TV, a terrestrial TV, and a cable TV. Furthermore, the wearable device, which is an information processing device capable of being directly worn on a human body like a watch, a pair of glasses, an accessory, a piece of clothing, a pair of shoes, or the like, may be connected to the music file providing server 10 or another user terminal at a remote place directly or through another information processing device via the network N.

In addition, the music providing system 100 may implement various embodiments of the music providing method by communicating with another user terminal that is separated from the user terminal 20.

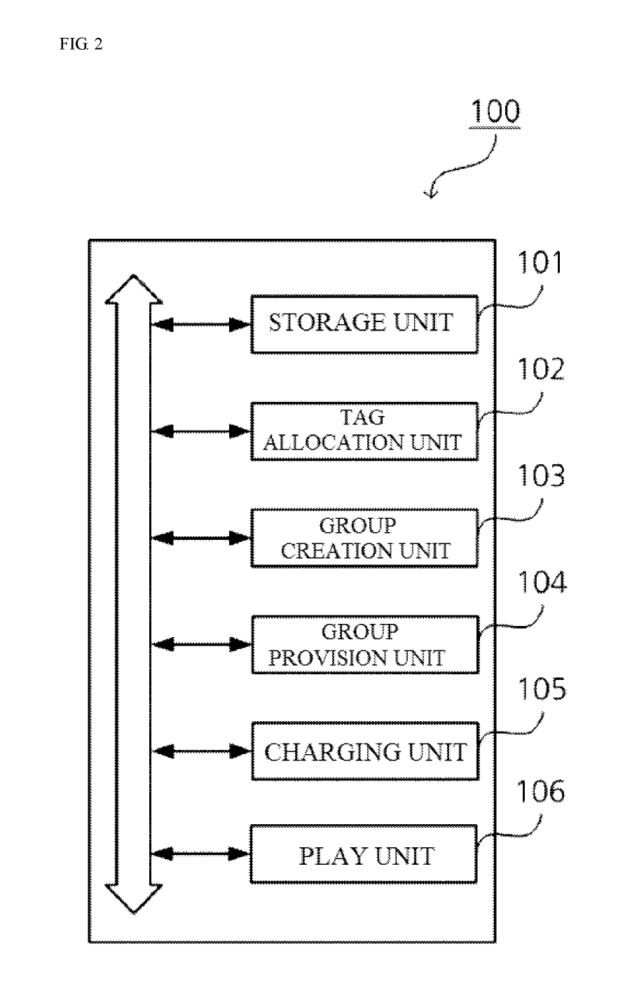

FIG. 2 is a block diagram showing the music providing system 100 according to an embodiment of the present invention. Referring to FIG. 2, the music providing system 100 may include a storage unit 101, a tag allocation unit 102, a group creation unit 103, a group provision unit 104, a charging unit 105, and a play unit 106. However, the music providing system 100 does not necessarily include all of the above elements. Thus, an embodiment of the present invention may be embodied by only some of the elements being included. Also, the above elements may be included in any one or both of the music file providing server 10 and the user terminal 20. One of the embodiments of the present invention may be embodied by operating the elements.

As a detailed embodiment, the storage unit 101 may store tag information corresponding to a music file such that the tag information is matched with the music file. In this case, the tag information, which is a kind of keyword information for illustrating the music file, may be stored and matched with the music file as separate data. A user may expect an atmosphere of music or search for a music file according to the tag information. The tag information may be set and stored by a provider of a music file before the music file is provided to a user. In this case, the tag information may be called self-tag information. On the other hand, any tag information added to a music file directly by a user may be called written-tag information. The music providing system 100, which is a module for providing an interface for receiving written-tag information form the user, may include the tag allocation unit 102.

The tag allocation unit 102 may receive any written-tag information regarding a music file from the user. At this point, the type of information receivable from the user as the written-tag information is not limited. That is, the user may enter a tag for the music file as he or she desires. For example, the user may enter the written-tag information depending on emotional states such as delight, excitement, and depression, atmospheres such as a rainy day, a clear day, and a calm day, or purposes such as a workout time, an eating time, and a concentrating time and may write a memorable place name, a person name, or the like as the written-tag information to allocate unique personal tag information to a music file. Furthermore, the tag allocation unit 102 may allocate image tag information to a music file by proposing images such as emoticons and receiving an image selected by a user.

As still another embodiment, the tag allocation unit 102 may perform the allocation of the tag information by recommending one or more pieces of recommended-tag information related to the written-tag information entered by the user and receiving an input for the recommended-tag information from the user. The recommended-tag information, which is tag information related to the written-tag information entered by the user, may include tag information having a similar notation or pronunciation or including the written-tag information, tag information having common features with the written-tag information, and the like. Alternatively, the tag allocation unit 102 may analyze pieces of tag information received from a plurality of users, regard pieces of tag information that are frequently input in sequence as related tag information, and recommend the related tag information as the recommended-tag information. Alternatively, the tag allocation unit may recommend popular tag information or pre-entered written-tag information. By proposing one or more pieces of recommended-tag information to the user, the tag allocation unit 102 may enable the user to select the recommended-tag information from a list or enter the recommended-tag information with text.

Also, when the tag information is received, the tag allocation unit 102 may convert the received tag information into the most similar piece of pre-registered other tag information and may register the converted tag information as the written-tag information.

As described above, the storage unit 101 may store the tag information received by the tag allocation unit 102 such that the tag information is matched with the music file.

The group creation unit 103 may create a music file group including one or more music files according to the tag information. For example, the group creation unit 103 may create a music file group including one or more music files according to the written-tag information. In this case, the group creation unit 103 may search for and group one or more music files including tag information identical to or related to the written-tag information to create the music file group. The related tag information may include tag information having a similar notation or pronunciation or including the written-tag information, tag information having common features with the written-tag information, and the like. Alternatively, the tag allocation unit 102 may analyze pieces of tag information received from a plurality of users, regard pieces of tag information that are frequently input in sequence as the related tag information, and group the related tag information. The play unit 106, which will be described later, may add music files included in the music file group created by the group creation unit 103 to a playlist and may play the playlist.

As another embodiment, the group creation unit 103 may classify the tag information including the written-tag information by using a DB management technique to create the music file group. For example, the group creation unit 103 may use operators such as “and,” “or,” “if,” incl.,” “excl.,” “not,” and “than” and may group music files depending on conditions such as “K-pop ballad songs since 2000; gloomy songs thereamong except for songs of boy groups,” “Dance music; high tempo songs except for K-pop songs,” and the like. In this case, personal conditions can be assigned by the written-tag information. For example, when a user enters “Cheolsoo,” “Haeundae,” or the like as written-tag information corresponding to one or more music files, the group creation unit 103 may create a music file group according to a condition “music to which the user has listened in Haeundae.”

A music file group may be created by being moved to a new folder and then stored. However, preferably, the music file group may be defined by music file group information. The music file group information refers to information capable of specifying a music file group including a list index regarding which music files are included in the music file group created by the group creation unit 103, a name of the music file group designated by the user, etc.

In association with the music file group, when the music providing system 100 communicates with another user terminal separate from the user terminal 20, the music providing system 100 may further include a group provision unit 104 configured to provide the music file group created by the group creation unit 103 to the other user terminal. In this case, the music file group may be provided by transmitting a music file or assigning an authority for real-time streaming of the music file. The group provision unit 104 may further provide tag information of music files included in the music file group to the other user terminal. Alternatively, the group provision unit 104 may provide written-tag information stored and matched with the music file to the other user terminal.

For example, the group provision unit 104 may provide the music file group to the other user terminal according to the user's input. When one or more music file groups are created and there are one or more other user terminals, the group provision unit 104 may receive a selected music file group and a selected other user terminal from the user and may provide the selected music file group to the selected other user terminal. That is, the user may directly present or recommend the music file group to another user.

As still another embodiment, the group provision unit 104 may provide music file group information regarding created music file groups to another user terminal, receive an input for selecting a music file group according to the music file group information from the other user terminal, and then provide the selected music file group to the other user terminal. The music file group information may be provided by the user terminal 20 uploading the music file group information regarding the created music file groups to the music file providing server 10. In this case, it is possible to obtain advantages in terms of a data amount, a time, and a rate by uploading only the music file group information rather than directly uploading the music file group including the music files.

A user-specific music file group created according to tag information including written-tag information according to an embodiment of the group provision unit 104 may be shared with other users. This has the same effect as sharing user-specific emotions with other users.

That is, when an embodiment of the group provision unit 104 is used, it is possible to compare music file groups created by a plurality of users, search for similar music file groups having a predetermined number of common music files, and recommend other music file groups of users who have created similar music file groups to each other. Thus, it is possible to provide a music file group adapted for a user's emotional taste or recommend a user having a similar emotional taste as a friend.

The music providing system 100 may further include a charging unit 105 configured to charge another user terminal a fee when a music file group is provided, and the charging unit 105 may compare music files included in the music file group with a list of music files possessed by the other user terminal to charge for only a missing music file. Thus, another user does not need to pay for a music file that was previously used when the music file is included in the provided music file group.

Also, the charging unit 105 may distribute benefits obtained by providing music file groups to other users to users who have provided the music file groups. Since individual pieces of music have new values by being combined with a new piece of music, this may be used to serve as a platform for an ordinary person to publish a music source group combined with a specific piece of music or a platform for a celebrity or an expert to publish a special-purpose omnibus album. For example, music file groups having themes of “prenatal education music recommended by a medical doctor,” “party music enjoyed by a top celebrity,” and the like may be proposed to other users. By distributing predetermined benefits to users who have provided music files groups, it is possible to pay for and encourage the creation of music file groups. It is possible for the other users to use a music file group created to be suitable for a purpose, a taste, an emotion, and an atmosphere and then pay for the music file group, thereby forming a new benefit structure for a music file market.

Also, the play unit 106 may play a music file stored in the storage unit 101. As described above, the storage unit 101 may include any one or both of the user terminal 20 and the music file providing server 10. As an embodiment of the present invention, when the storage unit 101 is included in the music file providing server 10 and the play unit 106 is included in the user terminal 20, the play unit 106 may download a music file from the music file providing server 10 and then store and play the downloaded music file or may play a music file stored in the music file providing server 10 in real time streaming.

According to an embodiment, the play unit 106 may receive an input for the tag information from a user, add a music file having tag information identical to or related to the received tag information to a playlist, and play the playlist. In this case, the tag information may include at least one of self-tag information and written-tag information stored and matched with the music file.

As another embodiment, the play unit 106 may receive an input for selecting a music file group created by the group creation unit 103 from a user, add a music file included in the selected music file to a playlist, and play the playlist. In this case, a list index of a music file to be played may be created to add the music file to the playlist with no need to move the music file to a separate folder.

The playlist is composed according to the tag information added to the music by the user. Thus, the user may receive a playlist suitable for a purpose, a taste, an emotion, and an atmosphere on a case-by-case basis. For example, when a user adds written-tag information “Cheolsoo,” which is the name of her ex-boyfriend, to one or more music files, the user may listen to music suitable for an emotion felt when she broke up with her boyfriend by entering the tag information “Cheolsoo” and receiving an associated playlist when the ex-boyfriend comes to mind.

According to an embodiment of the present invention, the play unit 106 may play music files included in the playlist in a random manner in an order sorted by a predetermined criterion, or in an order set by a user. Also, when values set for each music file (e.g., volume, bass, treble, distortion, echo, etc.) are received from the user, the music files in the group may be played according the received user input.

Also, when the play unit 106 plays one or more music files grouped by predetermined tag information and there are a plurality of pieces of tag information corresponding to the one or more music files, the play unit 106 may assign a weight to each piece of the tag information, sort music files included in the playlist, and play the music files in the group in the sorted order.

Also, the play unit 106 may check a storage position of a music file corresponding to predetermined tag information, list the storage position, and call up and play the music file stored in the storage position when the music file matched with the predetermined tag information is played.

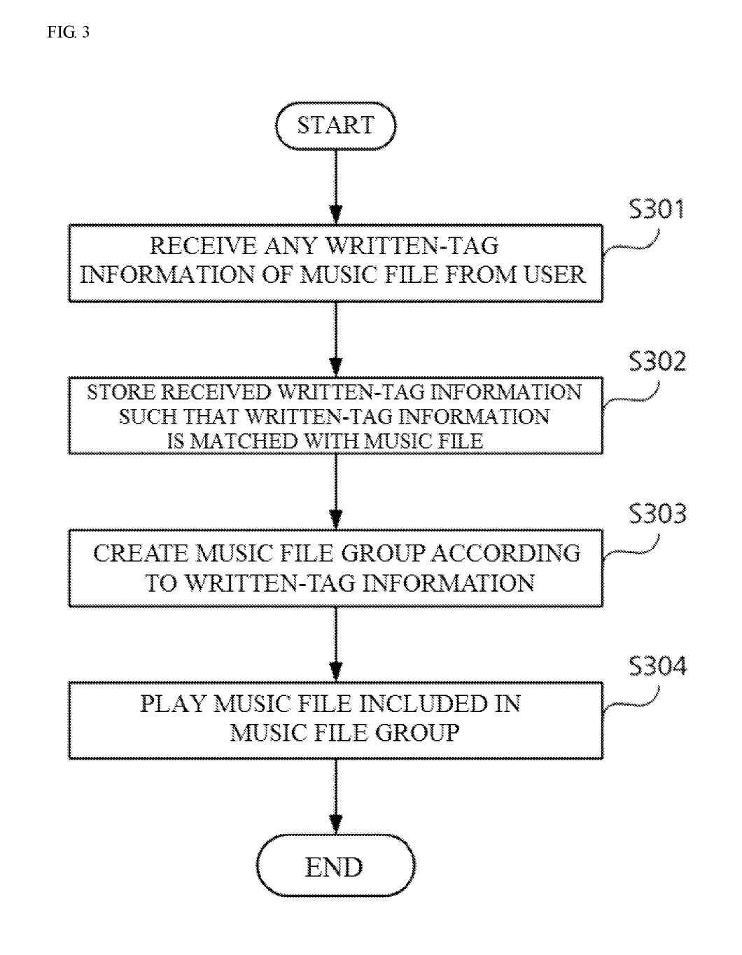

A music providing method according to an embodiment shown in FIG. 3 includes steps chronologically processed by the music providing system 100 shown in FIGS. 1 and 2. Accordingly, it can be seen that the above descriptions of the music providing system 100 shown in FIGS. 1 and 2, although omitted from the following description, may be applied to the music providing method according to the embodiment shown in FIG. 3.

According to an embodiment of the present invention, the music providing method may include storing tag information corresponding to a music file such that the tag information is matched with the music file and playing the music file.

Referring to FIG. 3, according to an embodiment, the music providing method may include receiving any written-tag information of a music file from a user (S301) and storing the received written-tag information such that the written-tag information is matched with the music file (S302).

In this case, step S302 may include recommending one or more pieces of recommended-tag information related to the written-tag information received from the user and receiving an input for one or more of the pieces of recommended-tag information from the user and storing the received recommended-tag information such that the recommended-tag information is matched with the music file.

Furthermore, the music providing method may further include creating a music file group according to the written-tag information (S303). A music file group including one or more music files may be created according to the written-tag information received from the user. In this case, the one or more music files may include a music file having tag information identical to or related to the written-tag information. In the following step, the music file included in the created music file group may be added to a playlist and then played.

As another embodiment, when the music providing system 100 communicates with another user terminal separate from the user terminal 20, step S303 may further include providing the created music file group to the other user terminal.

Thus, it is possible to share a user-specific music file group with other users by presenting or recommending the user-specific music file group to the other users.

In this case, the music providing method may further include charging the other user terminal a fee when the music file group is provided. The step of charging a fee may include comparing the music files included in the music file group with a list of music files possessed by the other user terminal and charging for only music files that are not possessed.

Also, the music providing method may include playing the music file included in the music file group (S104).

According to an embodiment, as step S104, the music providing method may include receiving an input for selecting a music file group from the user, adding a music file included in the selected music file group to a playlist, and playing the playlist.

According to another embodiment, in order to play a music file, the music providing method may include receiving tag information from a user, adding a music file having tag information identical to or related to the received tag information to a playlist, and playing the playlist.

The music providing method according to an embodiment that has been described with reference to FIG. 3 may be implemented as a recording medium including computer-executable instructions such as a computer-executable program module. The computer-readable recording medium may be any available medium accessible by a computer and may include volatile and non-volatile media and discrete and integrated media. Also, the computer-readable recording medium may include both a computer storage medium and a communication medium. The computer-readable recording medium includes the volatile and non-volatile media and discrete and integrated media which are implemented in any method or technique for storing information such as a computer-readable instruction, a data structure, a program module, or other data. The communication module typically includes a computer-readable instruction, a data structure, a program module, other data of a modulated data signal such as a carrier, and other transmission mechanisms and further includes any information transfer medium.

Also, the music providing method according to an embodiment of the present invention may be implemented by using a computer program (or a computer program product) including computer-executable instructions. The computer program may include a programmable machine instruction processed by a processor and may be implemented by using a high-level programming language, an object-oriented programming language, an assembly language, a machine language, or the like. Also, the computer program may be recorded in a tangible computer-readable recording medium (e.g., a memory, a hard disk, a magnetic/optical medium, or a solid state drive (SSD)).

Accordingly, the music providing method according to an embodiment of the present invention may be implemented by the computer programs being executed by a computing device. The computing device may include at least some of a processor, a memory, a storage device, a high-speed interface connected to a high-speed expansion port, and a low-speed interface connected to a low-speed bus and the storage device. Each of the components may be connected to each other by means of various buses and may be installed in a common mother board or mounted in another appropriate method.

Here, the processor may process instructions in the computing device, and examples of the instructions may include an instruction stored in the memory or the storage device in order to display graphic information for providing a graphic user interface (GUI) to an external input/output device such as a display connected to the high-speed interface. As another embodiment, a plurality of processors and/or a plurality of buses may be appropriately used together with a plurality of memories or memory-type devices. Also, the processor may be implemented with a chipset composed of chips including a plurality of independent analog and/or digital processors.

Also, the memory stores information in the computing device. As an example, the memory may be composed of non-volatile memory units or a set thereof. As another example, the memory may be composed of volatile memory units or a set thereof. Also, for example, the memory may be another type of computer-readable recording medium such as a magnetic or optical disk.

Also, the storage device may provide a large amount of storage space to the computing device. The storage device may be a computer-readable recording medium or an element including such a medium. For example, the storage device may include devices or other elements in a storage area network (SAN), and may be a floppy disk device, a hard disk device, an optical disk device, a tape device, a flash memory, or another semiconductor device or semiconductor device array similar thereto.

The above description is merely illustrative, and those skilled in the art should understand that various changes in form and details may be made therein without departing from the spirit and scope of the invention. The above embodiments are to be accordingly to be regarded as illustrative rather than restrictive. For example, while a single element may be distributed and then carried out, distributed elements may be carried out as a combination thereof.

Therefore, the scope of the present invention is defined not by the detailed description but by the following claims, and all changes or modifications within the claims and their equivalents should be construed as being included in the scope of the present invention.

1. A music providing method performed by a music providing system, the music providing method comprising:
storing tag information corresponding to a music file such that the tag information is matched with the music file; and
playing the music file.

2. The music providing method of claim 1, wherein the storing of tag information corresponding to a music file comprises:
receiving any written-tag information of the music file from a user; and
storing the received written-tag information such that the written-tag information is matched with the music file.

3. The music providing method of claim 2, wherein the storing of the received written-tag information comprises:
recommending one or more pieces of recommended-tag information related to the written-tag information received from the user; and
receiving one or more of the pieces of recommended-tag information from the user and storing the received recommended-tag information such that the recommended-tag information is matched with the music file.

4. The music providing method of claim 2, wherein the storing of the received written-tag information further comprises creating a music file group including one or more music files according to the written-tag information.

5. The music providing method of claim 4, wherein the creating of a music file group comprises providing the created music file group to another user terminal.

6. The music providing method of claim 5, wherein:
the providing of the created music file group to another user terminal comprises charging the other user terminal a fee when the music file group is provided; and
the charging of a fee comprises comparing music files included in the music file group with a list of music files possessed by the other user terminal and charging for only music files that are not possessed.

7. The music providing method of claim 1, wherein the playing of the music file comprises:
receiving an input for the tag information from a user;
adding a music file having tag information identical to or related to the received tag information to a playlist; and
playing the playlist.

8. The music providing method of claim 4, wherein the playing of the music file comprises:
receiving an input for selecting the music file group from the user;
adding a music file included in the selected music file group to a playlist; and
playing the playlist.

9. A music providing system that provides and/or plays a music file, the music providing system comprising:
a storage unit configured to store tag information corresponding to the music file such that the tag information is matched with the music file; and
a play unit configured to play the music file.

10. The music providing method of claim 9, further comprising a tag allocation unit configured to receive any written-tag information of the music file from a user, wherein
the storage unit stores the written-tag information received by the tag allocation unit such that the written-tag information is matched with the music file.

11. The music providing system of claim 10, wherein:
the tag allocation unit recommends one or more pieces of recommended-tag information related to the written-tag information received from the user and receives one or more of the pieces of recommended-tag information from the user; and
the storage unit stores the received recommended-tag information such that the recommended-tag information is matched with the music file.

12. The music providing system of claim 10, further comprising a group creation unit configured to create a music file group including one or more music files according to the written-tag information.

13. The music providing system of claim 12, wherein the group creation unit comprises a group provision unit configured to provide the created music file group to another user terminal.

14. The music providing system of claim 13, further comprising a charging unit configured to charge the other user terminal a fee when the music file group is provided, wherein
the charging unit compares the music files included in the music file group with a list of music files possessed by the other user terminal and charges for only music files that are not possessed.

15. The music providing system of claim 9, wherein the play unit receives an input for the tag information from a user, adds a music file having tag information identical to or related to the received tag information to a playlist, and plays the playlist.

16. The music providing system of claim 12, wherein the play unit receives an input for selecting the music file group from the user, adds a music file included in the selected music file group to a playlist, and plays the playlist.

17. A computer program performed by a music providing system and stored in a recording medium to perform the method of claim 1.

18. A computer-readable recording medium having a program recorded thereon to perform the method of claim 1.
